(19) United States
(12) Patent Application Publication
(10) Pub. No.: US 2007/0140187 A1
(43) Pub. Date: Jun. 21, 2007

(54) System and method for handling simultaneous interaction of multiple wireless devices in a vehicle

(76) Inventors: Daniel S. Rokusek, Long Grove, IL (US); Kranti K. Kambhampati, Palatine, IL (US); Edward Srenger, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/304,291

(22) Filed: Dec. 15, 2005

(51) Int. Cl. H04Q 7/24

(52) U.S. Cl. 370/338

(57) ABSTRACT

A wireless unit or hub for a vehicle includes a wireless communication interface, such as a Bluetooth® interface. The hub stores profiles for wireless devices that can actively interact with the hub. The wireless devices, which can be cellular phones, headsets, portable music players, and Personal Digital Assistants, are capable of providing audio data, visual data, or both to the hub. The hub monitors for wireless devices in a personal area network of the hub. Based on the profiles, the hub establishes wireless connections with the wireless devices. Using an arbitration scheme, the hub controls the delivery of audio and/or visual data provided by the wireless devices to one or more modules communicatively coupled to the hub. The modules, which can be a user interface module, audio module, visual modules, navigation system, and vehicle entertainment system, are capable of delivering audio, visual, or audio-visual data in the vehicle.

### FIELD OF THE DISCLOSURE

The subject matter of the present disclosure relates to a system and method for handling simultaneous interaction of multiple wireless devices in a vehicle.

### BACKGROUND OF THE DISCLOSURE

The IEEE 802.15 standard known as Bluetooth® is an open connection standard for wireless communication with a device, such as cellular telephone, printer, mouse, keyboard, personal digital assistant (PDA), and computer. In some instances, a Bluetooth®-enabled device can pair with another enabled device and transfer data within a relatively short distance (e.g., up to 100 meters) at a rate of up to 2.1 megabits per second. Until recently, Bluetooth® techniques have been used to handle one-to-one pairing between enabled devices. A number of devices from Motorola, Nokia, and Sony/Ericsson, however, can now support multi-point connections in Bluetooth®. Moreover, the Bluetooth® standard allows as many as seven Bluetooth®-enabled devices to be connected simultaneously to a hub.

Some typical implementations of Bluetooth® include pairing a mouse with a computer, a keyboard with a computer, or a PDA to a computer. In addition, some cellular telephones are Bluetooth®-enabled and can be used with a Bluetooth®-enabled wireless headset. In addition to wirelessly connecting peripheral devices to a computer or a cellular telephone to a headset, Bluetooth®-enabled communications systems are also available in a number of vehicles.

For vehicles, an example of an aftermarket Bluetooth® Hands-Free system is the Motorola HF820 Wireless Portable Speaker. In another example for vehicles, the blnc IHF1000 car kit from Motorola supports the Bluetooth® “Hands-Free Profile” and can be used with a cellular telephone enabled with the Bluetooth® “Hands-Free Profile.” The blnc IHF1000 car kit can be paired to four compatible Bluetooth® enabled cellular telephones, with one cellular telephone connected to the blnc IHF1000 car kit at a time. The blnc IHF1000 car kit can be operated with voice commands. In addition, the blnc IHF1000 car kit can be used to perform various functions, such as to answer or reject incoming calls with announced caller ID, to mute and un-mute calls, to dial by name with stored contacts, to dial by speaking the number, and to dial by the cellular telephone keypad. The blnc IHF1000 car kit allows the user to make calls using voice tags or name dial (as many as the cellular telephone supports), redial the last number, transfer in and out of privacy mode, accept or reject call waiting calls, toggle between calls, and transition call audio from the cellular telephone to the vehicle speaker. The blnc IHF1000 can also perform echo removal and noise reduction. Typically, Bluetooth®-enabled systems in vehicles use Bluetooth® Hands-Free Profile or Subscriber Identity Module (SIM) Access Profile.

### BRIEF DESCRIPTION OF THE DRAWINGS

FIG. 1 illustrates a schematic diagram of an automotive wireless system having a wireless unit or hub according to certain teachings of the present disclosure.

FIG. 2A illustrates an example of a cellular phone, a wireless headset, and a portable music device interacting with the disclosed hub.

FIG. 2B illustrates an example of a portable music device, a wireless headphone, and a cellular phone interacting with the disclosed hub.

FIG. 2C illustrates an example of a portable video player and a personal digital assistant interacting with the disclosed hub.

FIG. 2D illustrates an example of a portable navigation device and another device interacting with the disclosed hub.

FIG. 3A illustrates an embodiment of call device profiles in tabular form.

FIG. 3B illustrates an embodiment of audio device profiles in tabular form.

FIG. 3C illustrates an embodiment of visual device profiles in tabular form.

FIG. 3D illustrates an embodiment of multimedia data device profiles in tabular form.

FIG. 4A illustrates an embodiment of an audio priority scheme in tabular form for arbitrating audio data between devices in a vehicle.

FIG. 4B illustrates an embodiment of a visual priority scheme in tabular form for arbitrating visual data between devices in a vehicle.

FIG. 5A illustrates an embodiment of an audio arbitration scheme in tabular form for arbitrating audio data between devices in a vehicle.

FIG. 5B illustrates an embodiment of a visual arbitration scheme in tabular form for arbitrating visual data between devices in a vehicle.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. §112.

### DETAILED DESCRIPTION

Systems and methods for handling simultaneous interaction of multiple wireless devices are disclosed. In one embodiment, the system and methods are used to handle simultaneous interaction of multiple wireless devices in a vehicle. In an embodiment of a wireless interaction method, profiles are stored at a wireless unit or hub, which can be installed or incorporated into a vehicle. The profiles are for a plurality of wireless devices, which can be cellular telephones, wireless headsets, PDAs, portable music players, portable video players, portable navigation devices, laptop computers, or the like.

Each of the wireless devices is capable of providing audio data, visual data, or both. As used herein, audio data generally refers to data intended for or related to delivery of audio information in the vehicle. Thus, audio data can include, but is not limited to, voice of a cellular telephone call, audio for media (e.g., song, video, etc.), text-to-speech information, audio announcements, and audio for navigation (e.g., verbal driving directions). As used herein, visual data generally refers to data intended for or related to delivery of visual information in the vehicle. Thus, visual data can include, but is not limited to, caller ID information, contact information, phonebook information, instant message, e-mail, text, speech-to-text information, visual announcements, metadata for music files, video for movie files, visual navigation information, a map, and global positioning system (GPS) information.

The wireless unit monitors for wireless devices in a personal area network of the wireless unit. A first wireless connection is established between the wireless unit and a first wireless device based on the profile for the first wireless device. Likewise, a second wireless connection is established between the wireless unit and a second wireless device based on the profile for the second wireless device. Delivery of audio and/or visual data of the first and second wireless devices is then controlled according to a scheme. The scheme arbitrates the delivery of audio and/or visual data of the first and second wireless devices. For example, the arbitration scheme includes indications on what actions to take when certain types of audio or visual data are introduced at the wireless unit. In another example, the arbitration scheme includes indications on what actions to take when certain types of wireless devices introduce audio or visual data at the wireless unit.

The wireless unit in one embodiment includes one or more wireless communication interfaces, such as a Bluetooth® interface or an ultra wide band (UWB) interface. The wireless unit also includes memory for storing profiles for wireless devices. Each of the wireless devices is capable of providing audio data, visual data, or both. In addition, the wireless unit includes a controller communicatively coupled to the one or more wireless communication interfaces and the memory. The controller is configured to monitor for wireless devices in the personal area network of the wireless unit. The controller is also configured to establish a first wireless connection between the wireless unit and a first wireless device based on the profile for the first wireless device. Likewise, the controller is configured to establish a second wireless connection between the wireless unit and a second wireless device based on the profile for the second wireless device. Furthermore, the controller is configured to control delivery of audio and/or visual data of the first and second wireless devices according to an arbitration scheme, such as discussed previously.

The foregoing is not intended to summarize each potential embodiment or every aspect of the present disclosure. Let us now refer to the figures to describe the subject matter of the present disclosure in more detail.

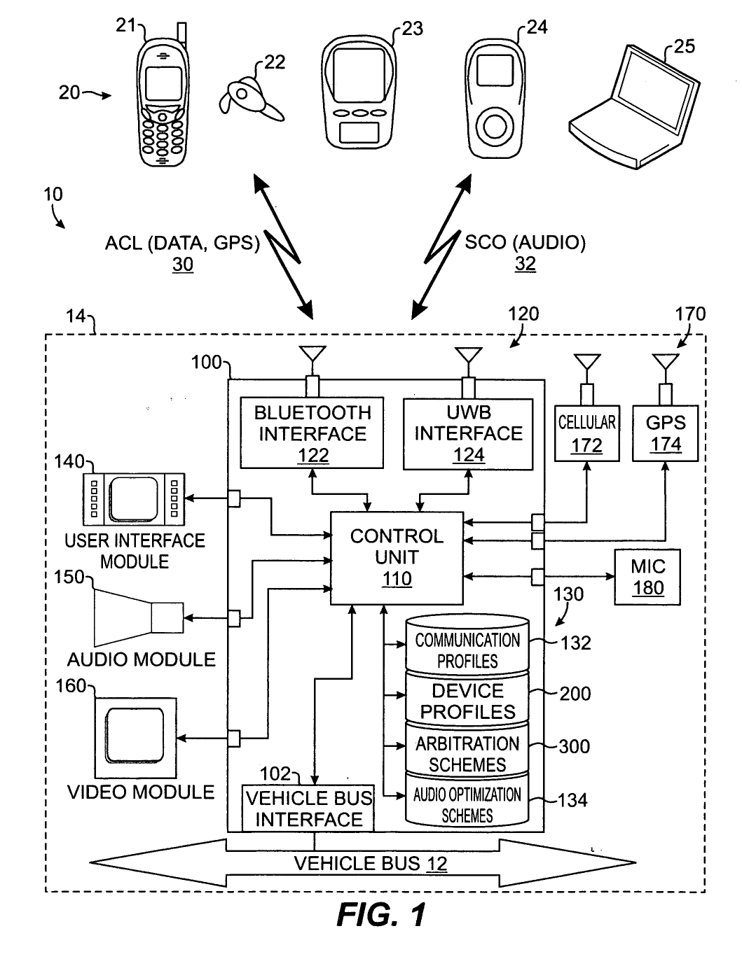

Referring to FIG. 1, an embodiment of an automotive wireless system 10 according to certain teachings of the present disclosure is schematically illustrated. In general, the automotive wireless system 10 can be part of a seamless mobility network for an automobile or vehicle. The system 10 includes a wireless unit or hub 100 for a vehicle 14. The hub 100 can be integrated into the vehicle 14 by the manufacturer or can be an aftermarket kit added to the vehicle 14.

The hub 100 has a processing or control unit 110, wireless interfaces 120, and memory 130. A vehicle bus interface 102 connects the hub 100 to an existing vehicle bus 12 using techniques known in the art, such as an On-Board-Diagnostic II (OBD-II) connection or other bus interface. The vehicle bus interface 102 provides the hub 100 with access to elements of the vehicle 14, such as power, ground, ignition, mute, mileage, speed, controls, parameters, features, information, etc.

The hub 100 is communicatively connected to one or more audio-enabled, visual-enabled, or audio-visual-enabled modules 140, 150, and 160 in the vehicle 14. Although shown as separate components in FIG. 1, the modules 140, 150, and 160 can be part of an overall system for the vehicle that includes the hub 100. The modules include, but are not limited to, a user interface module 140, an audio module 150, and a video module 160.

The hub 100 is communicatively connected to the user interface module 140 with an input/output interface. The user interface module 140 can be enabled for both audio and visual data and can be part of a navigation or entertainment system of the vehicle. In addition, the user interface module 140 can allow a user to control features of the hub 100 and the other modules 150 and 160 in the vehicle 14.

The hub 100 is communicatively connected to the audio module 150 with an output for line level audio. The audio module 150 can be a car stereo or can be part of an audio-enabled entertainment or navigation system incorporated into the vehicle 14. For example, the audio module 150 can be capable of rendering audio files. Alternatively, the audio module 150 can be an external speaker. For example, the hub 100 can include an output for amplified audio. Thus, the hub 100 may be capable of rendering audio files with a rendering engine and streaming the rendered audio to the external speaker of the audio module 150 for delivery in the vehicle 14.

The hub 100 is communicatively connected to the video module 160 with an output for video. The video module 160 can be an independent video display or can be part of a visual-enabled entertainment or navigation system incorporated into the vehicle 14. For example, the video module 160 can be capable of rendering video files. Alternatively, the hub 100 may be capable of rendering video files with a rendering engine and streaming the rendered video to the display of the video module 160 for delivery in the vehicle 14. In addition, one or more of the hub 100 and modules 140, 150, and 160 can be capable of converting text to speech and/or converting speech to text for delivery in the vehicle 14.

The hub 100 is also communicatively connected to one or more external interfaces 170, such as a cellular interface 172 and a GPS interface 174. Some other external interfaces include a Wi-Fi interface for the IEEE 802.11 standard, a hot spot interface, and other interfaces known in the art. Although not shown, the vehicle 14 can also include a Telematics unit known in the art and capable of wireless communication with external sources. The hub 100 is also connected to a microphone 180 with a microphone input. The microphone 180 can be a separate component or incorporated into the vehicle 14 and can connect to the hub 100 via the microphone input.

The hub 100 establishes a wireless personal area network (PAN) for the vehicle 14 in which multiple devices 20 can interact simultaneously with the hub 100. During operation, the hub 100 monitors for devices in the PAN of the hub 100 using techniques known in the art. Once devices 20 are detected, the hub 100 controls and optimizes the behavior of the devices 20 based on the current wireless environment in the vehicle 14 and based on the number and types of devices 20 currently interacting with the hub 100. The devices 20 can include, but are not limited to, a cellular telephone 21, a wireless headset 22, a PDA 23, a portable music player 24, a portable video player 25, a portable navigation device (not shown), a laptop computer (not shown), or the like. Each of these devices 20 is capable of wireless communication with a wireless interface 120 of the hub 100.

In one embodiment, the devices 20 and hub 100 are capable of wireless communication using the IEEE 802.15 standard (i.e., Bluetooth®) and associated communication protocols with a Bluetooth® interface 122 of the hub 100. In another embodiment, the devices 20 are capable of wireless communication using the IEEE 802.15.3a standard (i.e., UWB) and associated communication protocols with a UWB interface 122 of the hub 100. To communicate with the Bluetooth®-enabled devices, the hub 100 preferably supports the Bluetooth® 2.0 standard, which can enable the hub 100 to connect to as many as seven Bluetooth®-enabled devices simultaneously. With the Bluetooth® interfaces 122, the hub 100 uses asynchronous connection-less (ACL) links 30 for signaling packet types of GPS, video, and other data and uses synchronous connection oriented (SCO) links 32 for signaling packet types of audio data.

The hub 100 supports multiple wireless communication profiles 132 during operation so that the hub 100 can interact simultaneously with more than one of the devices 20. The wireless communication profiles 132 for the devices 20 are stored in memory 130 and relate to the various devices 20 capable of interacting simultaneously with the hub 100. Some examples of wireless communication profiles 132 for Bluetooth® include Serial Port Profile for data (e.g., GPS data from portable navigation devices), Headset 1.1, Hands free 1.0/1.5, Phone Book Access Profile (PBAP) 1.0, Advanced Audio Distribution Profile (A2DP), Audio/Video Remote Control Profile (AVRCP) 1.0, Messaging Access Profile 1.0, and Subscriber Identity Module (SIM) Access Profile. The hub 100 can support these and other Bluetooth® profiles as well as other wireless communication profiles known in the art. During operation, the hub 100 ensures with the profiles 132 that wireless communication between devices 20 and the hub 100 can occur seamlessly.

The hub 100 also has device profiles or information 200 and arbitration schemes 300 that are used for handling the simultaneous interaction of multiple devices 20. The device profiles 200 and arbitration schemes 300 can be entered and stored in memory 130 using the user interface 140, direct uploads from the devices 20, speech recognition techniques, universal plug and play (UPnP) technology, etc. For example, parameters, preferences and other information can be initially stored on the devices 20 and passed to the hub 100 when the device 20 is communicatively connected to the hub 100 or is placed into a holder or cradle (not shown) coupled to the hub 100. In addition or as an alternative, the device profiles 200 can be initially stored in memory 130 of the hub 100, and the hub 100 can access a device profile 200 for a particular device 20 based on identification of that device 20 using techniques known in the art. Preferably, the device profiles 200 and arbitration schemes 300 have default settings, which are initially configured and can be changed by the user. For example, the user can modify settings in the device profiles 200 and arbitration schemes 300 using voice input, the user interface module 140, or other available techniques.

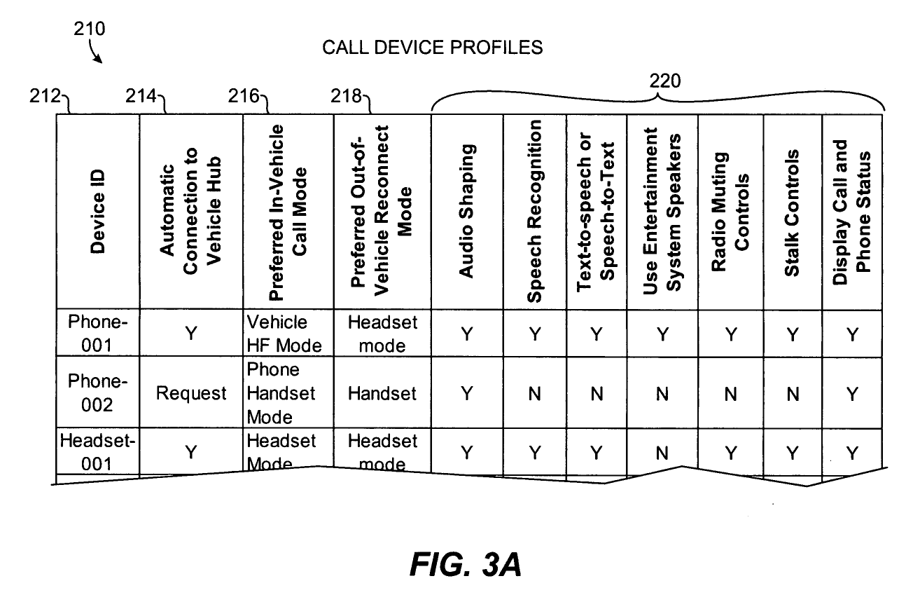

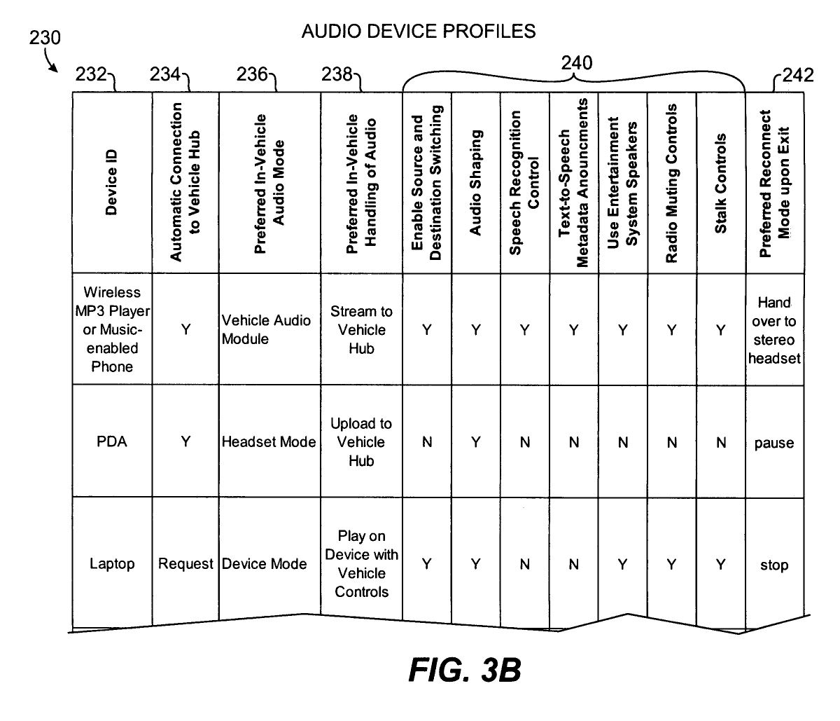

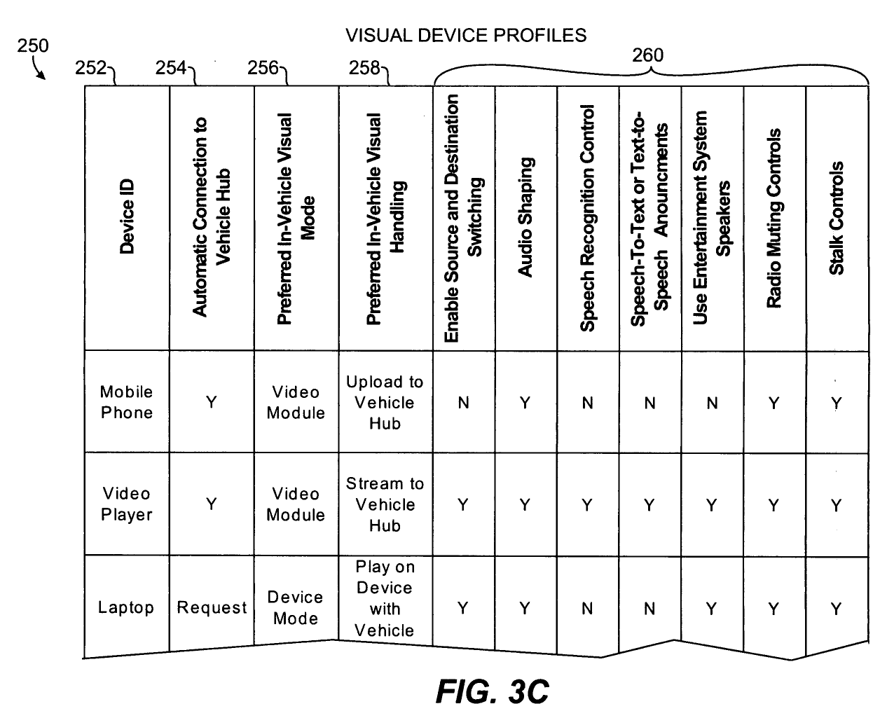

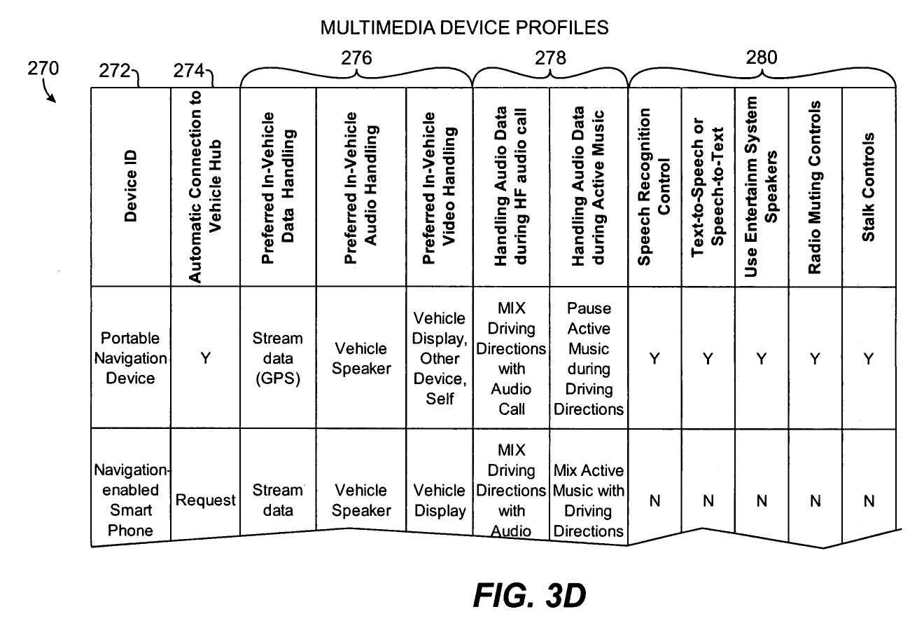

The device profiles 200 allow the hub 100 to manage multiple devices 20 simultaneously in a manner specific to user preferences and information defined in the profile 200. For example, the device profiles 200 can include one or more indications of whether to automatically establish a wireless connection between the hub 100 and a wireless device 20 in the PAN of the hub 100, which of the wireless communication profiles 132 to operate a wireless device 20 in the PAN of the hub 100, how to deliver audio or visual data with the hub 100, and how to transfer data between the hub 100 and a wireless device 20. Further details of the device profiles 200 are discussed below with reference to FIGS. 3A through 3D, which respectively cover call device profiles 210, audio device profiles 230, visual device profiles 250, and multimedia device profiles 270. It will be apparent that some devices 20 are capable of handling audio data, visual data, and other data. Accordingly, information in the various device profiles 210, 230, 250, and 270 of FIGS. 3A through 3D need not be separately configured. Moreover, one device 20 may have information defined by more than one of these exemplary profiles 210, 230, 250, and 270.

In FIG. 1, the hub 100 uses the arbitration schemes 300 to manage or arbitrate the delivery of audio and/or visual data in the vehicle 14 while multiple devices 20 are simultaneously interacting with the hub 100. In general, the arbitration schemes 300 arbitrate the delivery of audio and/or visual data in response to audio and/or visual data provided to the hub 100. For example, the arbitration schemes 300 can include one or more indications of whether to request user-selected instructions with the hub 100, whether to suspend delivery of audio or visual data from one of the wireless devices 20, whether to mix or simultaneously deliver audio data from two or more of the wireless devices 20 on one or more audio-enabled modules communicatively connected to the hub 100, and whether to superimpose, combine, or simultaneously deliver visual data from two or more of the wireless devices 20 on one or more visual-enabled modules communicatively connected to the hub 100. In addition, the arbitration schemes 300 can include one or more indications of whether to automatically disconnect a wireless connection between the hub 100 and at least one wireless device 20, whether to change at least one of the wireless devices 20 from a first wireless communication profile to a second wireless communication profile, whether to change how to deliver audio or visual data with the hub 100, and whether to change how to transfer data between the hub 100 and at least one of the wireless devices 20.

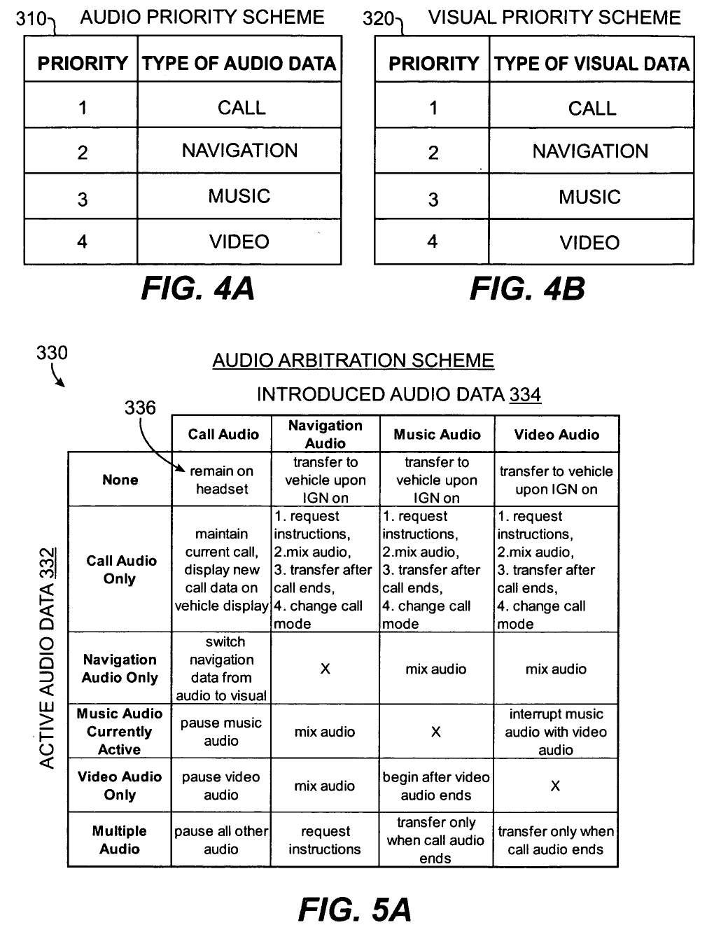

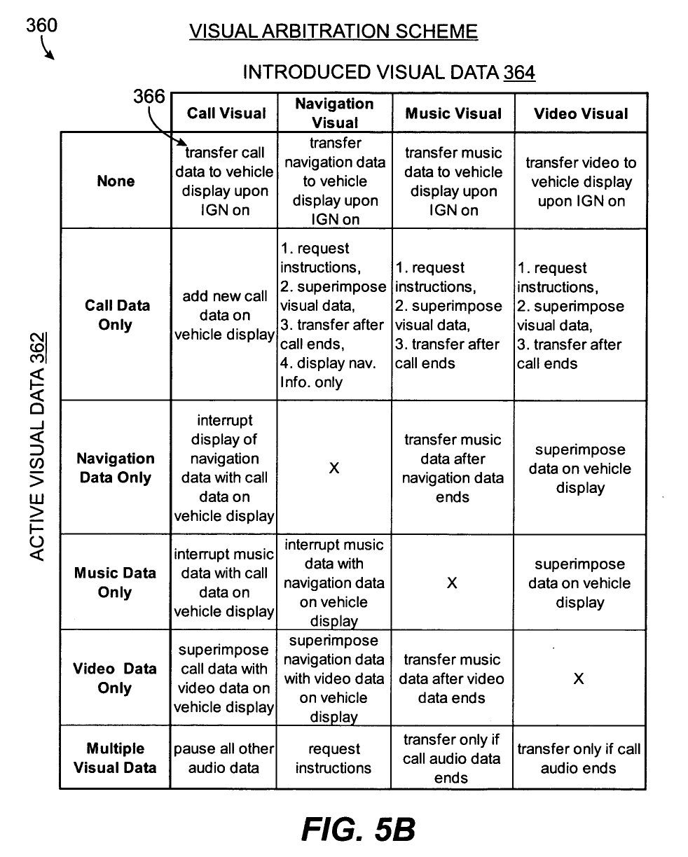

Further details of the arbitration schemes 300 are discussed below with reference to FIGS. 4A through 5B, which respectively cover an audio priority scheme 310, a visual priority scheme 320, an audio arbitration scheme 330, and a visual arbitration scheme 360. It will be apparent that some devices 20 are capable of handling various combinations of audio data, visual data, and other data. Accordingly, information in the arbitration schemes 310, 320, 330, and 360 of FIGS. 4A through SB need not be separately configured. Moreover, one device 20 may have information defined by more than one of these exemplary schemes 310, 320, 330, and 360.

In FIG. 1, the hub 100 uses the audio optimization schemes 134 to optimize the performance of the devices 20 and extend their capabilities. In general, the hub 100 and modules 140, 150, and 160 in the vehicle 14 have better or increased processing capabilities compared to the individual devices 20. Therefore, the hub 100 can use audio optimization schemes 134 in conjunction with such increased processing capabilities to optimize frequency response, turn on/off or modify noise suppression, and perform echo cancellation when managing interaction with the devices 20. Furthermore, given the limited bandwidth of headsets 22 and other devices 20, the hub 100 can use audio optimization schemes 134 to optimize speech recognition and hands free performance of such limited bandwith devices 20. The audio optimization schemes 134 can employ techniques known in the art for optimizing audio, speech recognition, and hands free performance.

With an understanding of the hub 100 and other components in FIG. 1, we now turn to examples of multiple devices 20 interacting with the hub 100 and concurrently discuss embodiments of device profiles 200 and arbitration schemes 300 according to the present disclosure.

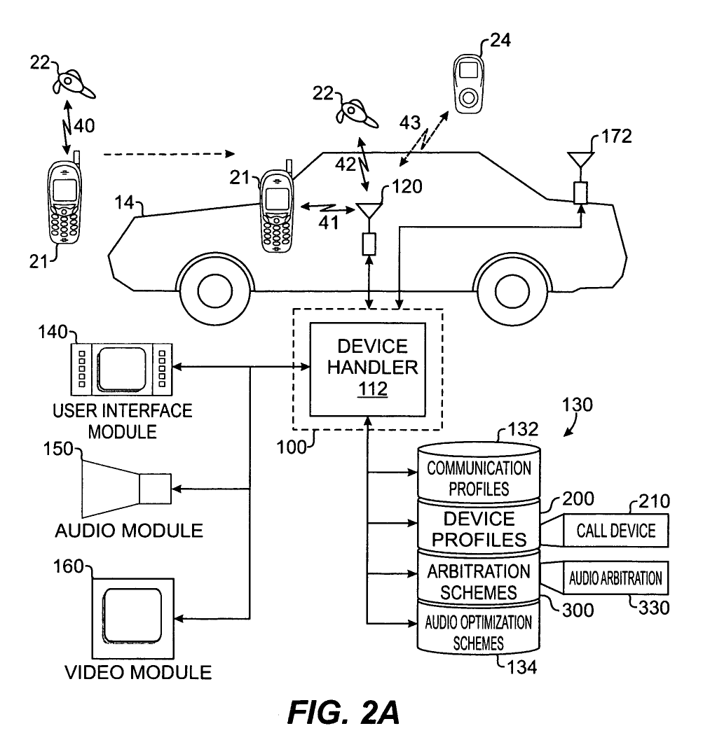

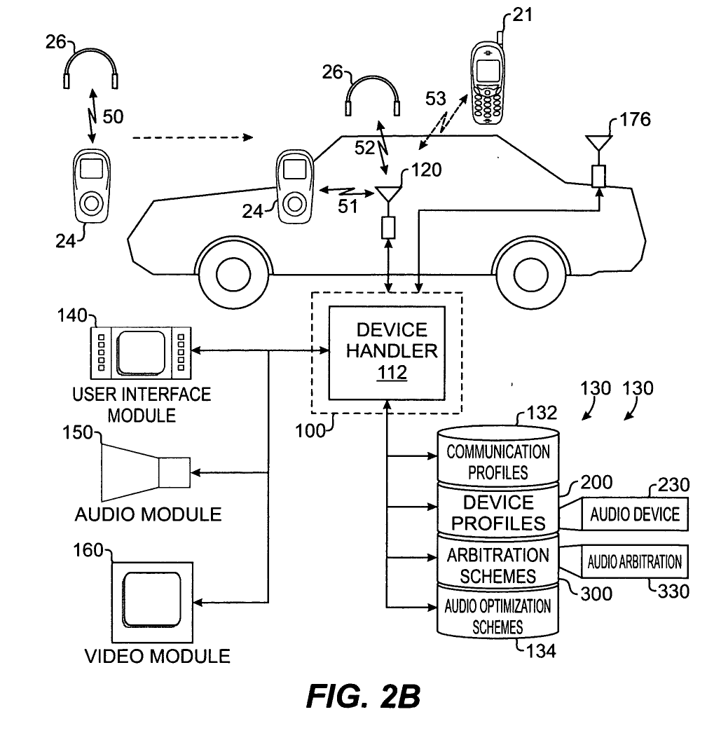

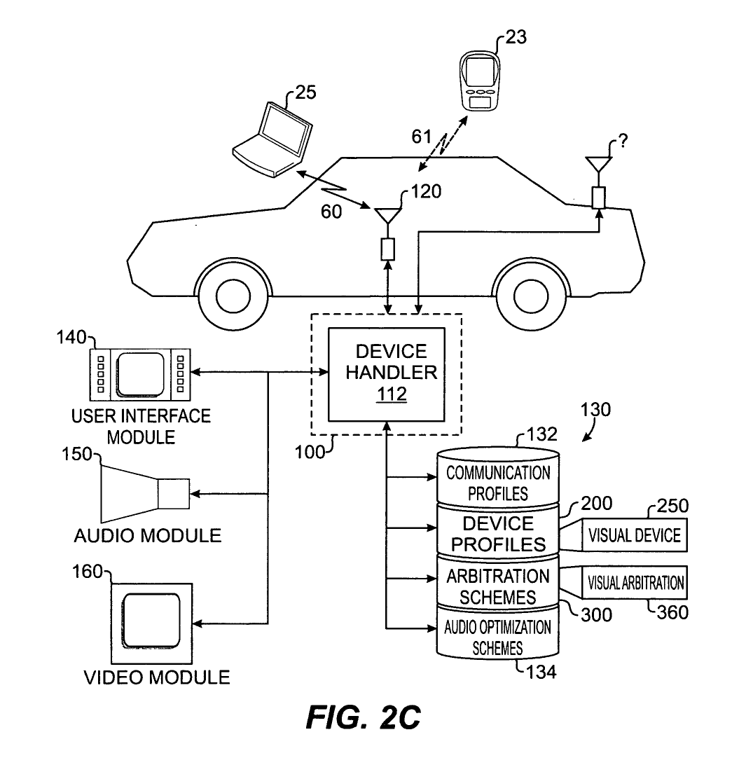

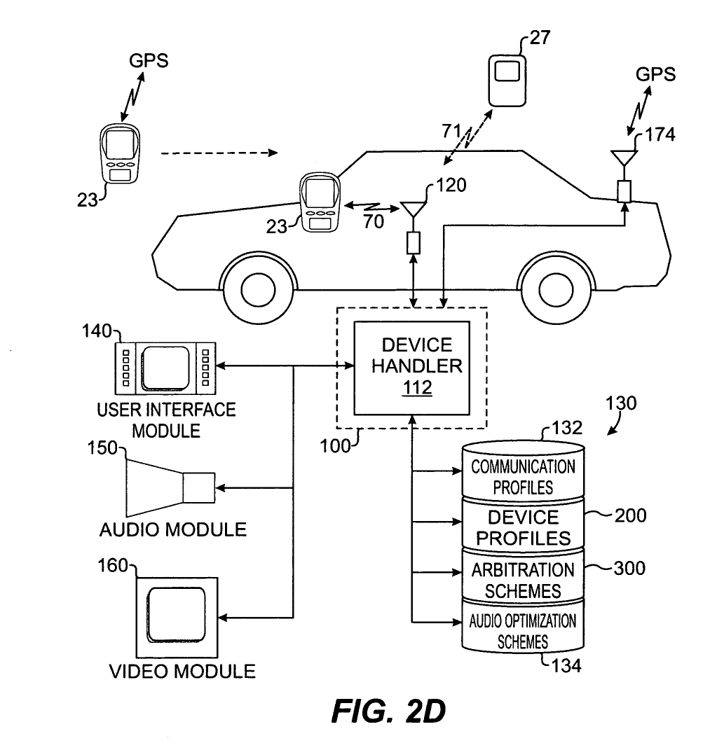

In FIG. 2A, a first example of multiple devices 21 and 22 seamlessly interacting with the disclosed hub 100 is illustrated. In this example, a user has a cellular telephone 21 and a wireless headset 22 interconnected by a hands-free wireless connection 40 when the user is outside her vehicle 14. The telephone 21 and wireless headset 22 may or may not be in use at the time, and additional devices (e.g., device 24) may or may not be already connected to the hub 100. The user enters her vehicle 14 while the telephone 21 and headset 22 are wirelessly connected. The hub 100 has a device handler 112 for handling the interaction of multiple devices with the hub 100. The device handler 112 is shown schematically as a component of the hub 100, but it will be appreciated that the device handler 112 can be embodied as software stored in memory and operating on the processing or control unit of the hub 100.

In the communication profiles 132, the device handler 112 supports wireless hands-free communication. Accordingly, the device handler 112 instructs the telephone 21 and headset 22 to disconnect from one another and to reconnect to the interface 120 of hub 100 in the vehicle 14 using links 41 and 42, respectively. The interface 120 is preferably a Bluetooth® or UWB interface (122 or 124; FIG. 1), discussed previously. Once connected to the hub 100, additional features and processing capabilities are now available for the devices 21 and 22. For example, the user can operate features of the headset 22 using the user interface module 140 of the vehicle 14. In addition, the user can use the volume controls, mute, send/end, etc. on the console of the user interface 140 rather than on the telephone 21.

To manage the devices 21 and 22, the device handler 112 accesses device profiles 200 that define parameters, user preferences, and other information for the devices 21 and 22. In general, the device profiles 200 define how to handle the devices when they enter and exit the vehicle 14 and define preferences and other parameters for when the devices are connected to the hub 100. For example, FIG. 3A illustrates an embodiment of call device profiles 210, which includes information for cellular telephones, headsets, and other call-related devices. Although shown in tabular form, it is understood that the call device profiles 210 can be embodied and stored in any form known in the art, such as part of a software routine, an algorithm, a relational database, a lookup table, etc.

In the call device profiles 210, each call-related device of the user that is known to the hub or currently connected to the hub has a separate identity or ID 212. As shown here, the device ID 212 is only schematically referred to as “Phone-001, Phone-002, headset-001, etc.” but is preferably a unique identifier of the device compatible with the communication profiles in use. For each call-related device, the profiles 210 also include indications or preferences of whether the device is to be automatically connected to the vehicle hub (Column 214), what is the preferred in-vehicle call mode of the device (Column 216), and what is the preferred out-of-vehicle reconnect mode of the device (Column 218). For example, Phone-001 is preferably automatically connected to the hub, uses the vehicle hands free mode while connected, and reconnects in a headset mode when exiting the vehicle.

In addition, the call device profiles 210 include indications or preferences on which features of vehicle systems and modules to use with the device (Columns 220). Some of the available features of the vehicle systems and modules include, but are not limited to, use of audio shaping techniques, speech recognition techniques, text-to-speech techniques, the entertainment system speakers, radio muting controls, stalk or steering wheel controls, and an in-vehicle display to show call and telephone status or information. The audio shaping techniques in columns 220 can include performing audio equalization, using echo and noise cancellation, or enhancing frequency response. These audio shaping techniques can embody the audio optimization schemes (134; FIG. 2A) used by the device handler (112; FIG. 2A) to shape audio for higher quality.

We now return to FIG. 2A for an example of how the device handler 112 uses such call device profiles 210 to handle the telephone 21 and headset 22. The device handler 112 determines from the call device profiles 210 how to handle a currently active call between the telephone 21 and headset 22 when the user enters the vehicle 14. Based on the indications and preferences in the call device profiles 210, the device handler 112 can determine to: (1) switch the active call over to a hands-free mode in the vehicle 14, (2) switch the phone 21 to handset mode, or (3) keep the telephone 21 and headset 22 in headset mode. In any of these cases, features of the user interface and audio modules 140 and 150 in the vehicle 14 are still available for the devices 21 and 22, because the devices 21 and 22 are connected to the hub 100 via links 41 and 42. Such features can be used to control the telephone 21, to perform speech recognition control, and to convert text to speech. For example, the feature of converting text to speech can be used to convert call metadata into speech to announce call information to the user with the audio module 150. Preferably, wideband speech mode is entered for speech recognition control.

In addition, the features available to the hub 100 in the vehicle 14 can enable the user to switch between telephone, headset, and hands free modes using in-vehicle controls on the user interface module 140 or using controls on the devices 21 and 22 themselves. Furthermore, features of the audio module 150 or entertainment system in the vehicle 14 can be used, such as the speakers, radio muting/un-muting, and stalk controls. In addition, a display of the user interface module 140 can be used to display call and telephone status and other information. When the user exits the vehicle 14 with the telephone 21 and headset 22, the hub 100 can automatically disconnect from them and instruct the devices 21 and 22 to re-connect according to their device profiles 200. If a call is active on the telephone 21 while the user exits, the hub 100 can hand over the active call in the headset mode or the telephone mode based on the device profiles 200.

While the telephone 21 and headset 22 are connected to the hub 100, however, the device handler 112 also uses arbitration schemes 300 to control delivery of audio and/or visual data in the vehicle 14. In general, the device handler 112 uses the arbitration schemes 300 to determine how to operate the telephone 21, headset 22 and any other devices and modules 140, 150 in the vehicle 14 in the event a new device (e.g., device 24) connects to the hub 100, a new call is received, or additional audio or visual data is currently active or introduced while a call is active in the vehicle 14.

One embodiment for the arbitration schemes 300 is illustrated in FIGS. 4A and 4B. FIG. 4A, which shows an audio priority scheme 310 used for arbitrating different types of audio data, and FIG. 4B shown a visual priority scheme 320 used for arbitrating different types of visual data. These priority schemes 310 and 330 can be applied individually to each device or can be applied generally to all current and potential devices interacting with the hub (100; FIG. 2A). The audio priority scheme 310 of FIG. 4A lists what types of audio data, such as call audio, navigation audio, music audio, and video audio, has priority over the other types. In like manner, the visual priority scheme 320 of FIG. 4B lists what types of visual data, such as call data, navigation data, music data, and video data, has priority over the other types.

We now return to FIG. 2A for an example of how the device handler 112 uses such priority schemes 310 and 320 of FIGS. 4A-4B. In this example, music audio from the portable music device 24 is currently active, and the device handler 112 has the currently active music audio being delivered in the vehicle 14 with the audio module 150. The telephone 21 and headset 22 are currently connected to the hub 112 but do not have an active call. A new call is introduced at the hub 100 from the telephone 21. From the device profile 200 for the telephone 21, the device handler 112 determines that it is preferred for the telephone 21 to use the audio module 150 for call audio. Because music audio is currently being delivered at the audio module 150, the device handler 112 determines from the audio priority scheme (310; FIG. 4A) to suspend delivery of the music audio with the audio module 150 and to instead deliver the call audio.

In addition to arbitrating the audio data, the device handler 112 uses the visual priority scheme 320 of FIG. 4B to arbitrate visual data. For example, the user interface module 140 is currently displaying music data, such as the title, artist, genre, etc., for the currently active music audio from the music device 24. Again, the new call is introduced at the hub 100 from the telephone 21. From the device profile 200 for the telephone 21, the device handler 112 determines that it is preferred for the telephone 21 to use the user interface module 140 display the visual call data. Because the visual data for the active music audio is currently being delivered at the user interface module 140, the device handler 112 determines from the visual priority scheme (320; FIG. 4B) to suspend displaying the music visual data and instead display the call visual data (e.g., name, number, and call length) on the user interface 140.

The priority schemes 310 and 320 of FIGS. 4A-4B offer one way of controlling the delivery of audio and visual data according to the present disclosure. The device handler 112, however, can use other forms of arbitration schemes 300 to arbitrate the audio and visual data of multiple devices interacting with the hub 100 in the vehicle 14. Referring to FIG. 5A, an embodiment of an audio arbitration scheme 330 is schematically illustrated. Again, although shown in tabular form, it will be understood that the scheme 330 can be embodied and stored in any form known in the art, such as part of a software routine, an algorithm, a relational database, a lookup table, etc. The audio arbitration scheme 330 defines a rubric of scenarios or situations where various forms of audio data are introduced and currently active in a vehicle. Each scenario is defined by a row 332 describing what type of audio data is currently interacting with the disclosed hub and active in the vehicle. Each scenario is also defined by a column 334 describing what type of audio data is introduced in the vehicle for interacting with the disclosed hub.

In the present embodiment, the rows 332 define situations where (1) no other, (2) only call-related, (3) only navigation-related, (4) only music-related, (5) only video-related, and (6) multiple forms of audio data are currently active. The columns 334 define situations where (1) call-related, (2) navigation-related, (3) music-related, and (4) video-related audio data is being introduced in the situations of rows 332. For each column/row scenario, the rubric contains an audio arbitration 336 used to arbitrate the audio data introduced in column 334 during the active audio data in row 332.

Although various examples of arbitration 336 are shown in the audio arbitration scheme 330, two scenarios depicted in the scheme 330 will be discussed. In one scenario, new call audio is introduced (column 334) when only call audio is currently active (row 332). In other words, the new call audio can be from another call coming into the currently active cellular telephone in the vehicle or can be from a new call coming into another cellular telephone interacting with the disclosed hub. The audio arbitration 336 for this scenario is to maintain the current call active on the vehicle systems and modules and to display data on the new call on the vehicle display of the user interface, for example.

In another scenario, new navigation audio is introduced (column 334) while only call audio is currently active (row 332). In other words, a navigation device in the vehicle provides audio driving directions to the disclosed hub for delivery with the vehicle's audio module while the user is currently using the audio module for an active call on their cellular telephone. Some of the possible options of the audio arbitration 336 for this scenario include (1) requesting instructions from the user, (2) automatically mixing the navigation audio with the current call audio on the audio module, or (3) automatically transferring the navigation audio over to the audio module only after the call audio ends. Another option (4) involves changing the call mode of the currently active call from a preferred delivery with a hands-free mode to delivery with a headset mode. Yet another option, described in more detail below, involves switching the delivery of the navigation directions from audio delivery to visual delivery for in-vehicle display, even though the device profile for a navigation device may indicate a preference for the audio delivery of the navigation directions.

The audio arbitration scheme 330, the types of scenarios defined by the rows 332 and columns 334, the types of arbitration 336 depicted in FIG. 5A are exemplary, and it will be appreciated with the benefit of the present disclosure that other schemes, scenarios, and types can be used. Thus, these and other forms of arbitrating the handling of audio in the vehicle will be apparent with reference to the teachings of the present disclosure.

We now return to FIG. 2A for an example of how the device handler 112 uses such an audio arbitration scheme 330 described above. In FIG. 2A, the telephone 21 and headset 22 are currently connected to the hub 100 with an active call. Based on the device profiles 200, the hub 100 has instructed the telephone 21 and headset 22 to connect to the interface 120. The device profiles 200 have also indicated that it is preferred that the active call be transferred to control in the vehicle so that the user interface module 140, audio module 150, and a microphone (not shown) in the vehicle 14 are used for the active call. While the call is active, however, music audio is introduced in the vehicle 14 from the portable music player 24 interacting with the hub 100. Based on the audio arbitration scheme 330, the device handler 112 determines to maintain the active call in hands free mode on the audio module 150 and transfer the music audio when the call ends. In other options, the device handler 112 can determine to mix the introduced music audio with the current call audio on the audio module 150 or to switch the active call to a headset mode between the telephone 21 and headset 22 and deliver the introduced music audio with the audio module 150.

In the previous discussion, examples of call-related devices and audio arbitration have been discussed. Continuing with this discussion, FIG. 2B illustrates a second example of audio devices 24 and 26 seamlessly interacting with the disclosed hub 100. In this example, the user has a wireless media player 24 with a wireless headphone 26 interconnected by a wireless connection 50. The wireless media player 24 can be a wireless MP3 player, a PDA, a cellular telephone, a laptop computer, or other device known in the art capable of playing music and wirelessly communicating with headphone 26. In the present example, the headphone 26 is wireless, but it can instead be a wired headset.

When the user enters the vehicle 14, she is currently listening to music on the player 24 and headphone 26. Based on the device profiles 200, the hub 100 instructs the player 24 and headphone 26 to automatically disconnect from one another and re-connect with the interface 120 of the hub 100 using links 51 and 52. For example, in the communication profiles 132, the hub 100 supports wireless communication protocols (e.g., ACL for Bluetooth®) for transferring music files between the media player 24 and the hub 100 via link 51 and streaming rendered music audio from the hub 100 to the Bluetooth®-enabled headset 26 via link 52.

In one embodiment, the player 21 can store digital media, such as MP3 music content, and can stream audio data packets to the hub 100 for rendering and delivery to the audio module 150 or the wireless headphone 26. Alternatively, the player 21 can upload the music file to the hub 100 for storage in the hub's memory 130 or elsewhere in the vehicle 14 and for delivery and rendering at the audio module 150. In another embodiment, the wireless player 21 can receive satellite or radio broadcast content from an external source, and reception of that content can either be relayed to the hub 100 via link 51 or received from an external vehicle interface 176, such as a satellite broadcast interface, coupled to the hub 100.

As with previous examples discussed above, the device handler 112 adapts operation of the devices 24 and 26 based on the device profiles 200. For example, FIG. 3B illustrates an embodiment of audio device profiles 230 in tabular form. Each audio device of the user that is known to the hub or actively connected to the hub has a separate identity or ID 232. For each device, the audio device profiles 230 preferably include indications or preferences on whether the device is to be automatically connected to the vehicle hub (Column 234), what is the preferred in-vehicle audio mode of the device (Column 236), and what is the preferred in-vehicle handling of audio (Column 238). For example, a wireless MP3 player or music-enabled phone may be configured to connect automatically to the vehicle hub (Column 234) and to use the vehicle entertainment system as the preferred in-vehicle audio mode (Column 236). In addition, the preferred in-vehicle handling of audio data for the MP3 player can be configured to steam audio data to the vehicle hub (Column 238). Other options for in-vehicle handling of audio data can involve uploading the audio data to the vehicle hub or rendering the audio data on the portable device but enabling control of the rendering with the vehicle systems and modules.

In addition, the audio device profiles 230 include indications or preferences on which features of vehicle systems and modules to apply to the device (Columns 240). Some of the features of the vehicle system and modules include, but are not limited to, enabling source and destination switching, audio shaping techniques (e.g., audio equalization), speech recognition control, text-to-speech metadata announcement, use of the entertainment system speakers, use of radio muting controls, use of stalk controls, and using a display to show music or audio data. Finally, the audio device profiles 230 can include indications or preferences on what is the preferred out-of-vehicle reconnect mode of the device (Column 242).

We now return to FIG. 2B for an example of how the device handler 112 uses such audio device profiles 230. When the user enters the vehicle 14, the device handler 112 automatically switches over delivery of the active music from the media player 24 to the audio module 150 of the vehicle's entertainment system. The actual rendering of the music file can be performed on the media player 24 and streamed to the hub 100 via link 51 and interface 120. Eventually, the device handler 112 can deliver the rendered music on the audio module 150. Alternatively, the music file that is currently active on the media player 24 can be transferred or uploaded to the hub 100 for rendering and delivery to the audio module 150.

Regardless of the preferred in-vehicle handling of audio data, the device handler 112 can switch over control of the music audio to the user interface module 140 or audio module 150 so that full features of vehicle 14 become available to the user. For example, the modules 140 and 150 can be used to switch between music sources and destinations, to shape audio for higher quality (e.g., to perform audio equalization), to perform speech recognition control, to perform text-to-speech for music metadata announcements, to play the music in the vehicle speakers, to mute/un-mute the music with radio controls, to use of stalk controls of the vehicle, and to display music names, time, etc. on an in-vehicle display. When the user exits the vehicle 14 with the player 24 and headphone 26, the hub 100 automatically disconnects from the player 24 and headphone 26, which re-connect based on their device profiles 200. If music audio is active when the user exits, for example, the hub 100 automatically hands the active music over to the headphone 26, or it pauses or stops the active music based on the device profiles 200.

As with the previous example discussed above, the device handler 112 also uses arbitration schemes 300 to arbitrate the handling of audio, video, and other data during operation. For example, the device handler 112 can use the audio priority scheme 310 in FIG. 4A or the audio arbitration scheme 330 in FIG. 5A for arbitrating different types of audio data. In one example of arbitrating audio in FIG. 2B, the hub 100 has music audio being streamed from the player 24 to the audio module 150 via the hub 100 and interface 120. The user also has a cellular telephone 21 actively connected to the hub 100 via link 53 with the interface 120. A call comes into the cellular telephone 21. From the audio arbitration scheme 330, the device handler 112 automatically pauses the current music audio in one option and allows the audio of the telephone call to be delivered and controlled from the audio module 150. When the call ends, the device handler 112 then automatically resumes rendering and delivery of the music audio with the audio module 150.

In another option, the device handler 112 automatically mixes the call audio with the currently active music audio delivered with the audio module 150. In yet another option, if headphone 26 is currently interacting with the hub 100, the device handler 112 can switch call handling to a headset mode when the call comes into the cellular telephone 150, and the device handler 122 can automatically reduce the volume level, mute, or pause the active music audio delivered on the audio module 150.

In still another option, the device handler 112 can change the in-vehicle delivery of audio data for one or more of the devices. For example, the portable music player 24 and headphone 26 may be those of a passenger and may be defined in the audio device profiles 200 as allowing automatic change in its mode of operation. Before a call is introduced, the current music audio is being streamed from the portable music player 24 to the hub 100 for delivery in the vehicle with the audio module 150. When a new call comes in to the connected telephone 21, however, the device handler 112 automatically changes the current mode of streaming music audio for delivery on the audio module 150 to a headset mode of delivering the music audio to the headphones 26 instead. Thus, the audio module 150 can be freed for delivering the new call audio of the telephone 21 in the vehicle 14, while the headphone 26 is used for the music audio of the music player 24. These and other forms of arbitrating the handling of audio in the vehicle 14 will be apparent with reference to the teachings of the present disclosure.

In the previous discussion, examples of call-related and audio-related devices and audio arbitration have been discussed. In FIG. 2C, however, a third example of devices 23 and 25 seamlessly interacting with the disclosed hub 100 is illustrated. In this example, the user has a portable video player 25, which can be a portable DVD player, a laptop computer, a video-enabled telephone, etc. Based on the device profiles 200, the hub 100 instructs the portable video player 25 to connect automatically to the interface 120 of the hub 100 using link 60. For example, in the communication profiles 132, the hub 100 supports wireless communication protocols (e.g., ACL for Bluetooth®) for transferring video files between the video player 25 and the hub 100 via link 60. In one embodiment, the video player 25 can store digital media, such as video content, and can stream video data packets to the hub 100 for rendering and delivery at the video module 160 of the vehicle 14. Alternatively, the video player 25 can upload the video file to the hub 100 for storage in the hub's memory 130 or elsewhere in the vehicle 14 and for rendering and delivery at the video module 160.

As with previous examples discussed above, the device handler 112 adapts operation of the video player 25 based on the device profiles 200. For example, FIG. 3C illustrates an embodiment of visual device profiles 250 in tabular form. Each visual device of the user that is known to the hub or actively connected to the hub has a separate identity or ID (Column 252). For each device, the visual device profiles 250 preferably include indications or preferences on whether the device is to be automatically connected to the vehicle hub (Column 254), what is the preferred in-vehicle visual mode of the device (Column 256), and what is the preferred in-vehicle handling of visual data (Column 258). For example, in the second row, a video player is configured to connect automatically to the vehicle hub (Column 254) and to use the video module of the vehicle entertainment system as the preferred in-vehicle visual mode of operation (Column 256). In addition, the preferred in-vehicle handling of visual data for the video player is to steam video data to the vehicle hub (Column 258). Other options for preferred in-vehicle handling of visual data involve uploading the video data to the vehicle hub or rendering the video data on the portable device but enabling control of the rendering with the vehicle systems and modules. In addition, the visual device profiles 250 include indications or preferences on which features of vehicle systems and modules to apply to the device (Columns 260), such as previously discussed.

As with the previous example discussed above, the device handler 112 of FIG. 2C also uses arbitration schemes 300 to arbitrate the handling of audio, video, and other data during operation. Referring to FIG. 5B, a visual arbitration scheme 360 is schematically illustrated in tabular form, although it will be understood that the scheme can be embodied and stored in any form known in the art, such as part of a software routine, an algorithm, a relational database, a lookup table, etc. The visual arbitration scheme 360 defines a rubric of scenarios. Each scenario is defined by a row 362 describing what type of visual data is currently interacting with the disclosed hub and active in the vehicle. Each scenario is also defined by a column 364 describing what type of visual data is introduced in the vehicle for interacting with the disclosed hub.

In the present embodiment of the scheme 360, the rows 362 define situations where (1) no other, (2) only call-related, (3) only navigation-related, (4) only music-related, (5) only video-related, and (6) multiple forms of visual data are currently active. The columns 334 define situations where (1) call-related, (2) navigation-related, (3) music-related, and (4) video-related visual data is being introduced to the situations in rows 362. For each column/row scenario, the rubric contains a visual arbitration 366 used to arbitrate the visual data that is introduced in column 364 while the visual data in the situation of row 362 is currently active.

Although several types of arbitration 366 are shown, two scenarios depicted in the scheme 360 will be discussed. In one scenario, new call-related visual data is introduced (first of columns 364) when only call-related data is currently active (first of rows 362). In other words, the new call-related visual data can be from another call coming into the currently active cellular telephone in the vehicle or can be from a new call coming into another cellular telephone interacting with the disclosed hub. The visual arbitration 366 for this scenario is to display the visual data of both the current call and the new call on an in-vehicle display, for example.

In another scenario, new navigation-related visual data is introduced (second of columns 364) while only call-related visual data is currently active (first of rows 362). In other words, a navigation device provides visual driving directions to the disclosed hub for delivery in the vehicle with the vehicle's user interface module while the module is currently displaying visual data for an active call on their cellular telephone. In FIG. 5B, some possible options of the visual arbitrations 366 for this scenario include (1) requesting instructions from the user what to do with respect to the navigation-related visual data, (2) automatically superimpose the navigation-related and call-related visual data on an in-vehicle display, (3) automatically transfer the navigation-related visual data over to an in-vehicle display only after the call audio ends, or (4) automatically display only the new navigation-related visual data on an in-vehicle instead of the call-related visual data. Thus, the visual arbitration 366 for this scenario can be predefined and configured in the visual arbitration scheme 360 so the device handler (112; FIG. 2C) can use the visual arbitration 366 when this scenario occurs while multiple devices and visual data are active and interacting with the disclosed hub (100; FIG. 2C).

The visual arbitration scheme 360, the types of scenarios defined by the rows 362 and columns 364, the types of arbitration 366 depicted in FIG. 5B are exemplary, and it will be appreciated with the benefit of the present disclosure that other schemes, scenarios, and types can be used. Thus, these and other forms of arbitrating the handling of audio in the vehicle will be apparent with reference to the teachings of the present disclosure.

We now return to FIG. 2C for an example of how the device handler 112 uses such visual device profiles 250 and visual arbitration schemes 360 when multiple devices 23 and 25 are interacting with the disclosed hub 100. When the user enters her vehicle 14, the portable video player 25 automatically connects with the in-vehicle hub 100. Video can then be requested using controls of the video module 160 or controls of the video player 25. Based on the visual device profiles 250, the hub 100 can upload a video file to the hub's memory 130 or other storage in the vehicle 14 and can render the video file for delivery in the vehicle 14 with the video module 160. Alternatively, the video player 25 can stream video data to the hub 100 for delivery in the vehicle 14 with the video module 160. In addition, the video data can be played on the portable video player 25 but controlled with the vehicle controls. For example, features of the vehicle system and module become available for control of the visual data, such as switching between video sources and destinations, audio shaping for higher quality music (equalization) and speech, speech recognition control, entertainment system leverage for use of speakers, radio muting/un-muting, use of stalk controls, etc.

When new visual data is introduced for delivery in the vehicle 14 from another visual device 23, the device handler 112 uses the visual arbitration scheme 360 to arbitrate how to handle the visual data from the multiple visual devices 23 and 25 interacting with the hub 100. Although not explicitly addressed here, it will be understood that the visual devices 23 and 25 may introduce new audio data for delivery in the vehicle 14 so that the device handler 112 can use an arbitration scheme 300 to arbitrate how to handle audio data from the multiple devices 23 and 25 interacting with the hub 100.

In one example, the visual device 23 is a navigation device or a PDA interacting with the hub 100 and introducing new visual driving directions (e.g., a driving route or map) for delivery in the vehicle 14. Based on the visual arbitration scheme 360, the device handler 112 determines to deliver the new visual driving directions in a visual display of the user interface module 140 while maintaining the delivery of the visual data associated with the video player 25 in the video module 160 of the vehicle 14. Alternatively, if the vehicle 14 has only one in-vehicle display, the device handler 112 can determine to suspend delivery of the video data while the new driving directions are displayed in the single in-vehicle display.

In another example, the device handler 112 can determine from the visual arbitration scheme 360 whether to switch delivery of the visual data of at least one of the wireless devices 23 or 25 from a first module communicatively coupled to the hub 100 to a second module communicatively coupled to the hub 100. One wireless device 25 can be a portable music player providing audio and visual data to the hub 100, and the device handler 112 can be delivering visual data (e.g., title, artist, etc.) on a display of the user interface module 140. The other wireless device 23 can be a portable navigation device, which introduces visual data (e.g., driving information or map) to the hub 100. In response, the device handler 112 switches the delivery of visual data from the portable music player 25 from the user interface module 140 to the video module 160, which may be a text only display on the dashboard or elsewhere in the vehicle 14. Then, the device handler 112 delivers the driving information or map on the user interface module 140, which may be associated with a vehicle navigation system.

These and other examples of visual arbitration will be apparent with the benefit of the teachings of the present disclosure.

As alluded to above, it is possible that the devices simultaneously interacting with the hub 100 are multimedia devices capable of handling various combinations of audio, visual, and other data. In this context, FIG. 2D illustrates a fourth example of devices 23 and 27 seamlessly interacting with the disclosed hub 100. In this example, the user has a portable navigation device 23 capable of wireless communication with the interface 120 via link 70. For example, the portable navigation device 23 can be a Smart Phone, a PDA, a dedicated portable navigation device, a laptop computer, or the like, and the portable navigation device 23 can communicate data with the hub 100 using ACL for Bluetooth®. The navigation device 23 may or may not be able to obtain GPS data and coordinates on its own using a GPS transceiver. While the user is outside of the vehicle 14, the portable navigation device 23 may be active or inactive and may be connected or not connected to other devices or to a GPS. Moreover, the navigation device 23 may or may not have ancillary features like hands free capability or music playing capability.

When the user enters the vehicle 14, the device handler 112 determines from the device profiles 200 how to handle the portable navigation device 23. For example, FIG. 3D illustrates an embodiment of multimedia device profiles 270 in tabular form. The multimedia device profiles 270 include device ID (Columns 272) and indications or preferences on whether the device is to be automatically connected to the vehicle hub (Column 274). For example, the disclosed hub can be configured to connect to a data device automatically or can be configured to request user selection to connect to a device.

In addition, the multimedia device profiles 270 include indications or preferences on what are the preferred in-vehicle data handling mode, audio handling mode, and video handling mode for the devices (Columns 276). For example, data handling for a device can be configured for streaming or uploading data (e.g., GPS data) between a device and the hub. Audio handling for a device can be configured to use speakers of the vehicle's audio module, use another portable device (e.g., a portable music player), or use the devices own capabilities to deliver audio data in the vehicle. Similarly, visual handling for a device can be configured to use a visual display of the vehicle's video module or user interface, use another portable device (e.g., a portable video player), or use the devices own capabilities to deliver visual data in the vehicle. In any of these instances, the in-vehicle controls can be used for the devices communicatively coupled to the disclosed hub.

In addition, the multimedia device profiles 270 can include indications or preferences for arbitrating situations when a device is simultaneously interacting with the hub when another, particular device is also interacting with hub. For example, columns 278 provide indications of how to handle audio data of the listed device during a hands-free audio call and during active music. Some options include missing driving directions with active audio of a call and pausing active music during driving directions, for example. Although these indications in columns 278 can be included in the audio or visual arbitrations schemes disclosed herein, they are included here to indicate that preferred forms of arbitration can be tied to a particular device in the device profiles of the disclosed hub. Finally, the multimedia device profiles 270 include indications or preferences on which features of vehicle systems and modules to apply to the device (Columns 280). As before, these features include speech recognition control, text-to-speech or speech-to-text capabilities, use of the entertainment system speakers, radio-muting controls, and stalk controls.

As with the previous examples discussed above, the device handler 112 of FIG. 2D also uses arbitration schemes 300 to arbitrate the handling of audio, visual, and other data during operation. For example, the device handler 112 uses the audio arbitration scheme 330 of FIG. 5A and the visual arbitration scheme 360 of FIG. 5B. With an understanding of the multimedia data profiles 200 and arbitration schemes 300 previously discussed, we return to FIG. 2D for an example of how the device handler 112 uses such multimedia data device profiles 270 and the arbitration schemes 300.

Based on the device profile 200, for example, the hub 100 instructs the navigation device 23 to connect automatically to the hub 100 with the in-vehicle hub 100 via the interface 120. To handle the navigation audio, the hub 100 can maintain the navigation audio for delivery on the portable navigation device 23, or the hub 100 can control delivery of the navigation audio to the vehicle speakers of the audio module 150 or to another device in the vehicle 14. Similarly, based on the device profiles 200, the hub 100 can maintain the navigation visual data for delivery on the portable navigation device 23 or can have it displayed on the user interface module 140 or another device in the vehicle 14. In addition, the navigation device 23 can be controlled by using controls on the device 23 or by using in-vehicle features, such as stalk controls, speech recognition controls, etc. of the user interface module 140 or audio module 150. Thus, the user can use and operate the portable navigation device 23 in conjunction with the hub 100, modules 140 and 150, and other vehicle systems.

In a first example, the portable navigation device 23 may not have a GPS transceiver but may have navigation software capable of using GPS data and giving driving directions (i.e., audio and/or visual driving instructions or routes). Alternatively, the GPS transceiver of the portable navigation device 23 may not be as effective in some situations as a transceiver of the GPS interface 174 for the vehicle 14. In other words, the portable navigation device 23 may be a GPS-enabled smart phone, and the vehicle's GPS transceiver of the GPS interface 174 may be more reliable. In any event, the portable navigation device 23 can use the GPS transceiver of the vehicle's GPS interface 174 by interacting with the hub 100. During use, the GPS interface 174 of the vehicle 14 obtains GPS data, and the hub 100 streams the GPS data to the portable navigation device 23 via link 70. Then, the portable navigation device 23 uses the received GPS data for delivery of driving directions or routes to users in the vehicle 14 either by using the device 23 or by sending the driving directions to the hub 100 via link 70.

In a second example, navigation audio and/or visual data (e.g., driving directions for a trip) can be transferred or uploaded from the navigation device 23 to the hub 100. In turn, the hub 100 can transfer or communicate the visual data to the user interface module 120 for displaying visual navigation data. In addition, the hub 100 can transfer or communicate the navigation audio to the audio module 150 for delivering the audio directions. Having the navigation data transferred to the hub 100, the user can take advantage of the enhanced processing capabilities, user interface 140, and audio system 150 in the vehicle 14. In a third example, navigation data (e.g., directions for a trip) stored in memory 130 at the hub 100 can be transferred to the portable navigation device 23 for delivery in the vehicle 14.

While the portable navigation device 23 is actively interacting with the hub 100, another device 27 connects to (or is already connected to) the hub 100. The other device 27 has audio and visual data for delivery in the vehicle 14, and the device handler 112 determines from the device profiles 200 and the arbitration schemes 300 how to handle the audio and visual data. Several situations follow to show examples of how the device handler 112 can handle the audio and visual data.

In a first situation, the other device 27 is a cellular telephone configured in its profile 200 to interact with the hub 100 in hands free mode such that call audio is to be delivered by the audio module 150. When a new phone call is introduced to the cellular telephone 27, the device handler 112 determines from the audio arbitration scheme 330 to mix the call audio with the current navigation audio (e.g., driving directions) from the navigation device 23 being delivered by the audio module 150.

Continuing with this first situation, the device profile 200 for the cellular telephone 27 may define that call data is preferably to be displayed with the user interface module 140. The user interface module 140, however, may be actively delivering visual navigation data from the navigation device 23. In this instance, the device handler 112 can determine from the arbitration schemes 300 to suspend display of the call data while current navigation data is displayed on the user interface module 140.

In a second situation, the device handler 112 delivers visual navigation data from the navigation device 23 with the user interface module 140. The other device 27 is a cellular telephone configured in its profile 200 to have visual phone book data displayed with the user interface module 140. While current navigation visual data (e.g., driving directions) from the navigation device 23 is being delivered by the user interface module 140, the user enters a command to access the phone book data with the user interface module 140 in order to dial a number hands free. The device handler 110 determines from the arbitration schemes 300 to suspend displaying the current driving directions on the user interface module 140 while the phone book data is displayed instead. Alternatively, the device handler 110 determines from the arbitration schemes 300 to switch delivery of the current navigation data from visual data displayed on the user interface module 140 to only audio data delivered with the audio module 150. Then, the phone book data can be displayed on the user interface module 140 so that the user can access and dial a number hands free while the driving directions from the navigation device 23 is still delivered in the vehicle 14 with the audio module 150.

In a third situation, the other device 27 is a portable music player configured in its profile 200 to stream music audio to the hub 100 for delivery by the audio module 150. Simultaneously, the navigation device 23 is configured in its profile 200 to stream navigation audio to the hub 100 for delivery by the audio module 150. When the navigation audio is routed to the audio module 150, any currently active music audio can be paused so that the navigation audio can be delivered in the vehicle 14. Alternatively, the routed navigation audio can be mixed with the current music audio on the audio module 150 depending upon the indications in the arbitration schemes 300. These and other forms of arbitrating the handling of audio, video, and other data in a vehicle will be more apparent with reference to the arbitration schemes discussed herein.

The foregoing description focuses on examples of handling the interaction of multiple wireless devices in the context of a vehicle having audio, visual, and/or user interface modules. It will be appreciated with the benefit of the present disclosure that the teachings associated with handling the interaction of multiple wireless devices in a wireless personal area network of a hub or wireless unit can be applied to other contexts. For example, teachings of the present disclosure can be applied to a laptop or other computer capable of establishing a wireless personal area network and interacting with multiple wireless devices that offer audio and/or visual data to be handled by the laptop or computer.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A wireless interaction method, comprising:
storing device information for wireless devices at a wireless unit, each of the wireless devices capable of providing audio or visual data to the wireless unit;
supporting a plurality of wireless communication profiles at the wireless unit, the wireless communication profiles governing wireless connections between the wireless unit and wireless devices;
monitoring for wireless devices in a personal area network of the wireless unit;
establishing a first wireless connection between the wireless unit and a first of the wireless devices based on the device information for the first wireless device;
establishing a second wireless connection between the wireless unit and a second of the wireless devices based on the device information for the second wireless device; and
controlling delivery of audio or visual data provided by the first and second wireless devices according to an arbitration scheme of the wireless unit.

2. The method of claim 1, wherein the device information for a wireless device comprises one or more of:
a first indication of whether to automatically establish a wireless connection between the wireless unit and a wireless device in the personal area network of the wireless unit;
a second indication of which of the wireless communication profiles to operate a wireless device in the personal area network of the wireless unit;
a third indication of how to deliver audio or visual data provided by a wireless device with the wireless unit; and
a fourth indication of how to transfer data between the wireless unit and a wireless device in the personal area network of the wireless unit.

3. The method of claim 1, wherein the arbitration scheme comprises, in response to audio or visual data provided to the wireless unit, one or more of:
a first indication of whether to request user-selected instruction with the wireless unit;
a second indication of whether to suspend delivery of audio or visual data from one of the wireless devices;
a third indication of whether to mix or simultaneously deliver audio data from two or more of the wireless devices on one or more audio-enabled modules communicatively connected to the wireless unit; and
a fourth indication of whether to superimpose, combine, or simultaneously deliver visual data from two or more of the wireless devices on one or more visual-enabled modules communicatively connected to the wireless unit.

4. The method of claim 1, wherein the arbitration scheme comprises, in response to audio or visual data provided to the wireless unit, one or more of:
a first indication of whether to automatically disconnect a wireless connection between the wireless unit and at least one wireless device;
a second indication of whether to change at least one of the wireless devices from a first wireless communication profile to a second wireless communication profile in response to audio or visual data provided to the wireless unit;
a third indication of whether to change how to deliver audio or visual data with the wireless unit; and
a fourth indication of whether to change how to transfer data between the wireless unit and at least one of the wireless devices.

5. The method of claim 1, further comprising enabling control of audio data for at least one of the wireless devices using one or more audio features of the wireless unit or an audio-enabled module communicatively coupled to the wireless unit.

6. The method of claim 1, wherein the act of controlling delivery of audio or visual data comprises controlling delivery of audio or visual data provided by the first and second wireless device to one or more audio-enabled or visual-enabled modules communicatively coupled to the wireless unit.

7. A wireless unit, comprising:
a wireless communication interface;
memory for storing device information for wireless devices, each of the wireless devices capable of providing audio or visual data to the wireless unit; and
a controller communicatively coupled to the wireless communication interface and the memory, the controller configured to:
support a plurality of wireless communication profiles at the wireless unit, the wireless communication profiles governing wireless connections between wireless devices and the wireless unit;
monitor for wireless devices in a personal area network of the wireless unit;
establish a first wireless connection between the wireless unit and a first of the wireless devices based on the device information for the first wireless device;
establish a second wireless connection between the wireless unit and a second of the wireless devices based on the device information for the second wireless device; and
control delivery of audio or visual data provided by the first and second wireless devices according to an arbitration scheme of the wireless unit.

8. The wireless unit of claim 7, wherein the one or more wireless communication interfaces comprise an interface using IEEE 802.15 standard or 802.15.3a standard.

9. The wireless unit of claim 7, wherein the wireless unit comprises one or more interfaces coupleable to a user interface module, an audio module, a video module, a vehicle video display, a vehicle stereo, a vehicle entertainment system, or a vehicle navigation system.

10. The wireless unit of claim 7, wherein the wireless communication profiles are selected from the group consisting of Serial Port Profile, Headset Profile, Hands free Profile, Phone Book Access Profile, Advanced Audio Distribution Profile, Audio/Video Remote Control Profile, Subscriber Identity Module Access Profile, and Messaging Access Profile.

11. The wireless unit of claim 7, wherein the device information for a wireless device comprise one or more of:
a first indication of whether to automatically establish a wireless connection between the wireless unit and a wireless device in the personal area network of the wireless unit;
a second indication of which of the wireless communication profiles to operate a wireless device in the personal area network of the wireless unit;
a third indication of how to deliver audio or visual data provided by a wireless device with the wireless unit; and
a fourth indication of how to transfer data between the wireless unit and a wireless device in the personal area network of the wireless unit.

12. The wireless unit of claim 7, wherein the wireless devices are selected from the group consisting of a cellular phone, a smart phone, a wireless headset, a Personal Digital Assistant, a portable music player, a portable video player, a portable navigation device, a laptop, and a computer.

13. The wireless unit of claim 7, wherein the arbitration scheme comprises a plurality of priorities assigned to types of audio or visual data.

14. The wireless unit of claim 13, wherein the types of audio or visual data are selected from the group consisting of call-related, navigation-related, music-related, and video-related.

15. The wireless unit of claim 13, wherein controlling delivery of audio or visual data comprises suspending delivery of audio or visual data for one of the wireless devices having a first type of audio or visual data with a lower priority than a second type of audio or visual data for the other wireless device.

16. The wireless unit of claim 7, wherein the arbitration scheme comprises, in response to audio or visual data provided to the wireless unit, one or more of:
a first indication of whether to request user-selected instruction with the wireless unit;
a second indication of whether to suspend delivery of audio or visual data from one of the wireless devices;
a third indication of whether to mix or simultaneously deliver audio data from two or more of the wireless devices on one or more audio-enabled modules communicatively connected to the wireless unit; and
a fourth indication of whether to superimpose, combine, or simultaneously deliver visual data from two or more of the wireless devices on one or more visual-enabled modules communicatively connected to the wireless unit.

17. The wireless unit of claim 7, wherein the arbitration scheme comprises, in response to audio or visual data provided to the wireless unit, one or more of:
a first indication of whether to automatically disconnect a wireless connection between the wireless unit and at least one wireless device;
a second indication of whether to change at least one of the wireless devices from a first wireless communication profile to a second wireless communication profile in response to audio or visual data provided to the wireless unit;
a third indication of whether to change how to deliver audio or visual data with the wireless unit; and
a fourth indication of whether to change how to transfer data between the wireless unit and at least one of the wireless devices.

18. The wireless unit of claim 17, wherein at least one wireless device comprises a cellular phone capability enabled with Headset Profile and Hands-Free Profile, and wherein the second indication indicates whether to change the wireless connection for the at least one wireless device from the Headset Profile to the Hands Free Profile or from the Hands-Free Profile to the Headset Profile.

19. The wireless unit of claim 17, wherein the third indication indicates whether to switch delivery of audio or visual data from a first module communicatively coupled to the wireless unit to a second module communicatively coupled to the wireless unit.

20. The wireless unit of claim 17, wherein the third indication indicates whether to switch from a first mode of delivering audio data to a second mode of delivering visual data of at least one wireless device or to switch from the second mode of delivering visual data to the first mode of delivering audio data of at least one wireless device.

21. The wireless unit of claim 17, wherein the fourth indication indicates whether to switch from a first mode of steaming data to a second mode of loading data or to switch from the second mode to the first mode.

22. The wireless unit of claim 7, further comprising enabling control of audio data for at least one of the wireless devices using one or more audio features of the wireless unit or an audio-enabled module communicatively coupled to the wireless unit.

23. The wireless unit of claim 22, wherein the one or more audio features are selected from the group consisting of an audio shaping feature, a speech recognition feature, a text-to-speech feature, a muting feature, a stalk control feature, an audio equalization feature, an echo cancellation feature, a noise cancellation feature, and a frequency response feature.
